(19) United States
(12) Patent Application Publication
(10) Pub. No.: US 2004/0019860 A1
(43) Pub. Date: Jan. 29, 2004

(54) Test program emulators, methods, and computer program products for emulating a test program of an integrated circuit semiconductor device

(76) Inventor: Seuk-whan Lee, Suwon-city (KR)

Correspondence Address: MYERS BIGEL SIBLEY & SAJOVEC, PO BOX 37428, RALEIGH, NC, 27627, US

(21) Appl. No.: 10/413,666

(22) Filed: Apr. 15, 2003

(30) Foreign Application Priority Data
Apr. 16, 2002 (KR) 2002-0020711

(51) Int. Cl. G06F 17/50

(52) U.S. Cl. 716/4

(57) ABSTRACT

A test program emulator for an integrated circuit semiconductor device includes an emulator control program that is configured to accept a device specification in the form of a computer file and a test program as inputs, to analyze the text of the test program to obtain test items, and to store the test items in a virtual register. An emulator execution program is configured to virtually execute the test program and to extract virtual test results of commands that are compatible with the device specification. An emulator decision program is configured to compare the virtual test results with the device specification to decide whether the test program passes or fails and outputs the decision result.

### RELATED APPLICATION

This application claims the benefit of Korean Patent Application No. 2002-20711, filed Apr. 16, 2002, the disclosure of which is hereby incorporated herein by reference.

### FIELD OF THE INVENTION

The present invention relates generally to integrated circuit devices and, more particularly, to test emulators and methods of test emulation for integrated circuit devices.

### BACKGROUND OF THE INVENTION

A purpose for electrically testing integrated circuit semiconductor devices is to screen out defects by detecting defects in the devices generated in an assembly process. In general, electrical testing of integrated circuit semiconductor devices is performed using a computer system called a tester.

The tester is comprises a computer, which controls the entire tester system, and additional equipment attached to the computer. The additional equipment may include, for example, programmable power supplies for supplying voltages and currents to semiconductor devices, direct current (DC) parameter measurement units, a waveform formatter driven by an algorithmic pattern generator and a timing generator, and pin electronics connecting to pins of semiconductor devices. A test program executing in the computer of a tester controls the additional equipment to test the electrical functions of semiconductor devices.

FIG. 1 is a flowchart illustrating the configuration and the test procedure of a conventional test program for testing the electrical functions of an integrated circuit semiconductor device. Referring now to FIG. 1, a pin configuration block S1 of a test program defines the connections between the pins of a semiconductor device and the channels in the pin electronics of a tester. A format block S2 defines the connection information on a programmable power supply of a tester for DC testing and a DC parameter measurement unit. A pattern definition block S3 and a timing definition block S4 define information on the use of an algorithmic pattern generator, a timing generator, and a waveform formatter for a function test and a timing test.

Having defined the connections and other information, a test program of the integrated circuit semiconductor device tests the electrical functions of the device. Generally, a pin contact test S5, a DC test S6, and a function and timing test S7 are performed to separate defective devices from normal semiconductor devices, then the electrical function test for the semiconductor devices is complete. When a test result does not satisfy a test criterion or standard, i.e., device specifications, a next test for the device is not performed. Instead, the device is determined to be defective S8 and the testing ends.

FIG. 2 is a flowchart that illustrates procedures for using a test program in a tester. A design engineer developing integrated circuit semiconductor device components and a test engineer prepare a test program with reference to a device specification. The test program, also known as a source program, is generally written in a text type S10. In this case, the languages used in configuring the test program vary between tester manufacturers. Presently, C-language is mainly used for test programs; however, tester manufacturers generally develop their own graphical user interface (GUI) software to make debugging easier.

Next, the source program is compiled to an execution file, which comprises machine language instructions. Most errors in the source program are screened by a debugging process S11. Thereafter, the debugged execution file is transferred to a tester, which performs an electrical function test on an integrated circuit semiconductor device S12.

Although the conventional method for operating the test program screens a portion of the errors in the test program in the compiling process, not all of the errors can be screened. More specifically, in the compiling process, errors are detected by checks, such as “are commands correctly written in a source program?” and “have commands been correctly used for predetermined specifications?” For example, when it is assumed that a command “measure” in a DC test is typed as “maesure,” the debugging tool detects the error and generates an error message. Errors caused by a programmer in preparing a source program that satisfy the predetermined specifications for using the commands, however, may not be detected. For example, it is assumed that a command block of “screen semiconductor devices having time of propagation delay of over 50 ns” is used. In this case, if the programmer inputs 500 ns instead of 50 ns in the command block by mistake, the computer cannot detect the error in the debugging process, because 500 ns satisfies the predetermined specifications for using the command.

The problem may occur in a program block for a state transition process of the test program, which performs a function and timing test. For example, in a DRAM device, to test a timing parameter such as t_{RCD}, i.e., RAS to CAS delay time, a state transition condition, such as “write data after activating a main cell region of a DRAM,” is prepared in a test program block. If a programmer inadvertently omits a command such as “activate a main cell region of a DRAM” in a command block of a source program for testing a t_{RCD} timing parameter, however, the computer cannot detect the error, because the command block satisfies the specifications of using the command.

At present, because a source test program for a general semiconductor device typically comprises hundreds or thousands of lines and a plurality of operators are used in the source test program, errors made by a programmer cannot easily be detected by the debugging tool. As a result, a test program having errors may not completely screen all defective integrated circuit semiconductor devices. Therefore, when an end user implements the defective semiconductor device in electrical equipment, fatal defects may occur. For example, when a defective integrated circuit semiconductor device is implemented in medical equipment, the medical equipment may operate incorrectly or not operate at all. When a defective integrated circuit semiconductor device is implemented in a spacecraft, the spacecraft may operate incorrectly or not even launch.

### SUMMARY OF THE INVENTION

According to some embodiments of the present invention, a test program emulator for an integrated circuit semiconductor device comprises an emulator control program that is configured to accept a device specification in the form of a computer file and a test program as inputs, to analyze the text of the test program to obtain test items, and to store the test items in a virtual register. An emulator execution program is configured to virtually execute the test program and to extract virtual test results of commands that are compatible with the device specification. An emulator decision program is configured to compare the virtual test results with the device specification to decide whether the test program passes or fails and outputs the decision result.

In other embodiments, the device specification and the test program are prepared for the same device.

In still other embodiments, the device specification is written in a text type.

In still other embodiments, the test program is a source code program.

In further embodiments, the test items comprise an alternating current (AC) timing specification and a state transition specification of a semiconductor device.

In still further embodiments, the virtual register of the emulator control program is a register of a computer in which the emulator program is executed.

In still further embodiments, the test program emulator further comprises a waveform generator that is configured to convert the device specification and the virtual test results into graphic format. In particular embodiments, the waveform generator is generated by a graphical user interface (GUT) language.

In other embodiments, the test items comprise an item for deciding whether the test program passes or fails.

In still other embodiments, the test program emulator executes in a personal computer (PC) or a workstation.

Although embodiments of the present invention have been described above primarily with respect to test program emulator embodiments, embodiments of methods of emulating a test program, operating a test program, and computer program products for carrying out the same are also provided.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a flowchart that illustrates a conventional configuration and test procedure of a test program for testing the electrical functions of an integrated circuit semiconductor device;

FIG. 2 is a flowchart illustrating conventional test program operations;

FIG. 3 is a block diagram that illustrates an emulator program for a test program of an integrated circuit semiconductor device and operations thereof according to some embodiments of the present invention;

FIG. 4 is a block diagram that illustrates an emulator control program included in an emulator program and operations thereof in accordance with some embodiments of the present invention;

FIG. 5 is a block diagram that illustrates an emulator execution program included in an emulator program and operations thereof in accordance with some embodiments of the present invention;

FIG. 6 is a block diagram that illustrates an emulator decision program included in an emulator program and operations thereof in accordance with some embodiments of the present invention;

FIG. 7 is a flowchart that illustrates a test order in operating an emulator program in accordance with some embodiments of the present invention;

FIG. 8 is a block diagram that illustrates emulation operations of an emulator program using a test program in accordance with some embodiments of the present invention; and

FIG. 9 is a flowchart that illustrates methods of operating a test program for testing an integrated circuit semiconductor device according to some embodiments of the present invention.

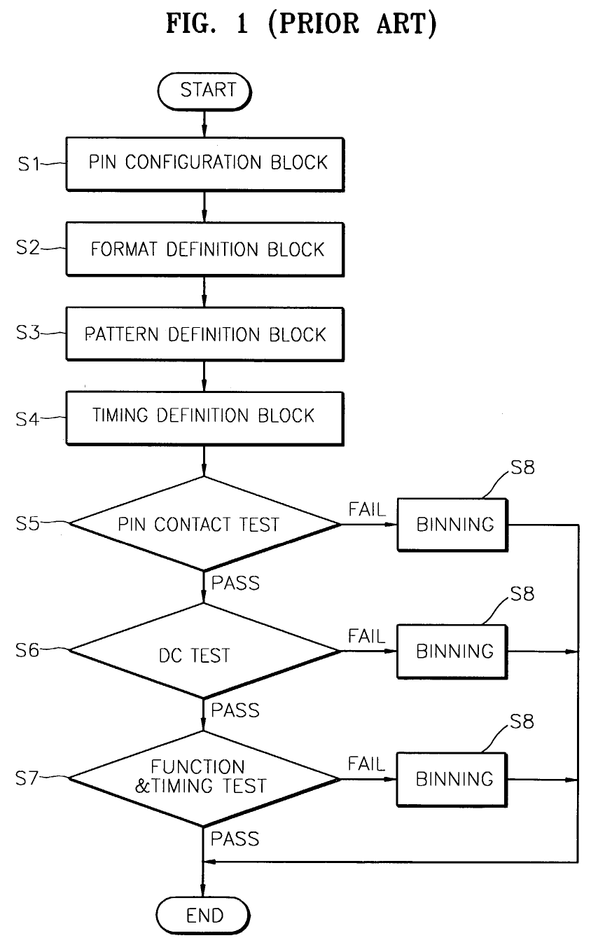

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures. It will also be understood that when an element is referred to as being “connected” or “coupled” to another element, it can be directly connected or coupled to the other element or intervening elements may also be present. In contrast, when an element is referred to as being “directly connected” or “directly coupled” to another element, there are no intervening elements present.

In addition, the configuration of a tester is described herein with reference to the Advantester, which is used for electrically testing integrated circuit semiconductor memory devices. It will be understood, however, that the tester may be embodied in other configurations, such as the Teradyne tester or the Schlumberger tester. Moreover, even though virtual test results are extracted from a timing test and a state transition test, the virtual test results can be extracted from other types of tests, such as a direct current (DC) test. Accordingly, the embodiments are provided so that this disclosure will be thorough and complete and should not be construed as limited to the particular embodiments set forth herein. The present invention may be embodied as test program emulators, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described hereinafter with reference to flowchart and/or block diagram illustrations of methods, systems, and computer program products in accordance with exemplary embodiments of the invention. These flowchart and/or block diagrams further illustrate exemplary operations of integrated circuit device test program emulation in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

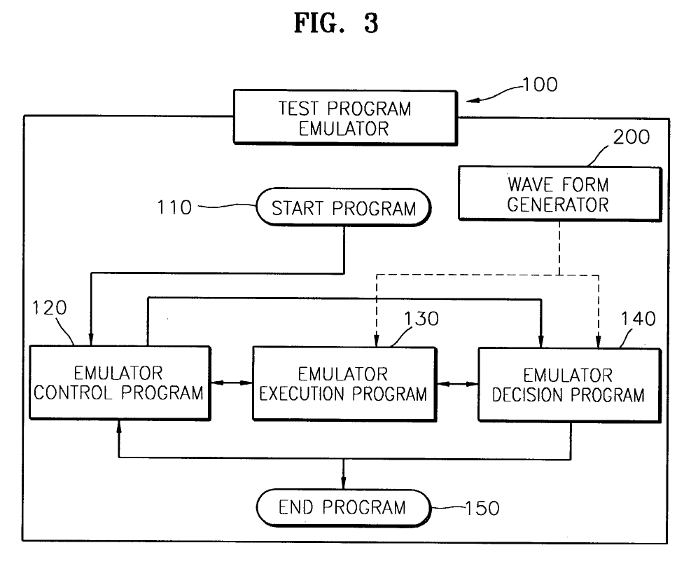

FIG. 3 is a block diagram that illustrates an emulator program for a test program of an integrated circuit semiconductor device and operations thereof according to some embodiments of the present invention. Referring now to FIG. 3, an emulator 100 for a test program of a semiconductor device, according to some embodiments of the present invention, comprises an emulator control program 120, an emulator execution program 130, and an emulator decision program 140. In addition, a start program 110 and an end program 150 are included in the test program emulator 100 while a waveform generator 200 is arranged as a subroutine program.

The test program emulator 100, according to some embodiments of the present invention, starts from the emulator control program 120, performs the emulator execution program 130, and ends at the emulator decision program 140. During execution the emulator program may move within the emulator control program 120, the emulator execution program 130, the waveform generator 200, and the emulator decision program 140 in any particular order.

The emulator control program 120 calls a device specification, which is in the form of a computer file, and a test program to be emulated, from the outside and analyzes the text of the test program. The emulator control program 120 selects test items, for example, an alternating current (AC) timing test and a state transition test, based on the analyzed test program text and stores the test items in a virtual register of a computer in which the test program emulator 100 is run.

The emulation execution program 130 virtually executes the test program and extracts the virtual test results of the AC timing test and the state transition test from the execution results, processes the results, and compares the virtual test results with the device specification.

The emulation decision program 140 compares the virtual test results with the AC timing specification and the state transition specification of the device to determine whether the emulated test program passes or fails, and outputs the results of the determination to the outside. The results of the determination include errors that dare not detected by conventional debugging processes.

The waveform generator 200 is a utility program that is produced by a graphical user interface (GUI) language. The program of the waveform generator 200 converts the AC waveform represented by graphics into text, which is used in the test program for testing a semiconductor device, or converts the text type AC timing conditions used in the test program for testing the integrated circuit semiconductor device into waveform type graphics. Accordingly, the emulator execution program 130 or the emulator decision program 140 of the test program emulator 100 may call the program of the waveform generator 200 via a subroutine to perform the AC timing test.

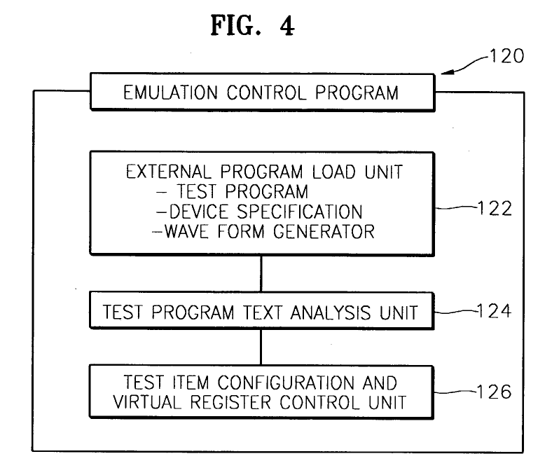

FIG. 4 is a block diagram that illustrates an emulator control program included in an emulator program and operations thereof in accordance with some embodiments of the present invention. Referring now to FIG. 4, the emulator control program 120 includes a command block as an external program load unit 122. The external program load unit 122 loads the test program to be emulated and the text type device specification into the test program emulator. If needed, the emulator control program 120 may define a sequence which loads the waveform generator program and controls the overall flow of the test program emulator 100 (refer to FIG. 3).

The device specifications are files including text type electrical specifications of integrated circuit semiconductor device components to be tested, for example, DC conditions such as an operating current (Icc), a leakage current (I_{H}/I_{OH}), and a voltage level (V_{OH}/V_{OL}), a state transition condition, and an AC timing condition. The text for the AC timing condition can be converted into AC waveform type graphics in the waveform generator 200 (refer to FIG. 3). The test program is loaded into a computer, such as a PC or workstation, in which the test program emulator 100 (refer to FIG. 3) is run in the form of a source file not an execution file.

In addition, the emulator control program 120 includes a test program text analysis unit 124 for analyzing the text of the loaded test program. The emulator control program 120 further includes a test item configuration and virtual register control unit 126 for selecting the AC timing condition and the state transition condition, which are test items, from the test program text analysis unit 124 and storing the test results in a virtual register. In this case, the virtual register is an imaginary register in a computer such as a PC or a workstation in which the test program emulator is run, and not a virtual register in a computer that controls a tester.

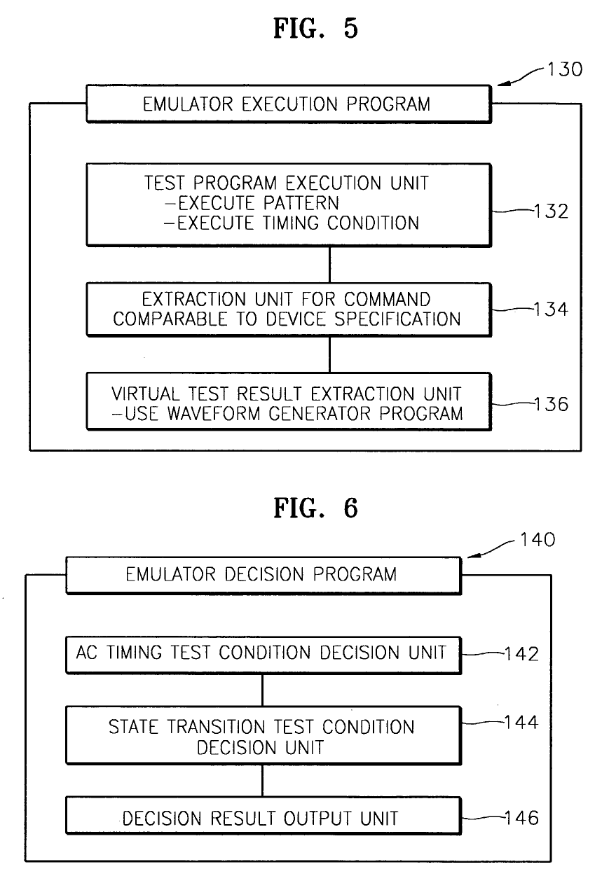

FIG. 5 is a block diagram that illustrates an emulator execution program included in an emulator program and operations thereof in accordance with some embodiments of the present invention. Referring now to FIG. 5, the emulator execution program 130 includes a test program execution unit 132, a command extraction unit 134 for extracting commands which are comparable to or compatible with the device specification from the test program, and a virtual test result extraction unit 136.

The test program execution unit 132 virtually operates patterns used in the function test of the test program and the AC timing test to determine whether the test program passes or fails, while not directly operating hardware as additional equipment under the same conditions as operating the test program in the tester. Accordingly, in this case, only mathematical operations are executed and the actual integrated circuit semiconductor device and hardware are not tested.

The command extraction unit 134 runs the command lines of the test program line-by-line to selectively extract the commands comparable to the device specification. Generally, most of the commands in the test program are for establishing test conditions, while a small number of the commands are for an actual test.

The virtual test result extraction unit 136 runs the commands for the actual test to process the AC timing test condition and the state transition test condition into text. Thereafter, the virtual test result extraction unit 136 calls the waveform generator subroutine to convert the text type conditions into graphic format.

FIG. 6 is a block diagram that illustrates an emulator decision program included in an emulator program and operations thereof in accordance with some embodiments of the present invention. Referring now to FIG. 6, when the emulator control program 120 and the emulator execution program 130 have analyzed and executed the test program and extracted the virtual test results for the test items, the emulator decision program 140 compares the virtual test results with the device specification one-by-one to determine whether the test program passes or fails.

An AC timing test condition decision unit 142 compares the virtual test results extracted from the test program with the AC timing test condition of the device specification and determines whether the test program passes or fails. For example, it is assumed that a limit value for a time of propagation delay is defined as 50 ns in a device specification. If a programmer has incorrectly entered 500 ns or 60 us instead of 50 ns, which is not detected by a debugging process, the AC timing test condition decision unit 142 detects the error and outputs an error message. Consequently errors that satisfy the criteria for using commands but are not detected in the prior art, can be detected and corrected according to the present invention. A state transition test condition decision unit 144 establishes a state transition criterion in the electrical function test of a semiconductor device to determine whether the process of the test program coincides with the established state transition criterion of the device specification. In a case where the process of the test program does not coincide with the state transition criterion of the device specification, an error message is output.

For example, to test a DRAM timing parameter, such as t_{RCD}, i.e., RAS to CAS delay time, it is assumed that a state transition specification such as “write data after activating a main cell region of a DRAM” is defined in the device specification which is in the form of a computer file. If a programmer omits the portion of “after activating a main cell region of a DRAM” by mistake, the state transition test condition decision unit 144 detects an error in the test program and generates an error message.

A decision result output unit 146 stores the comparison results from the AC timing test condition decision unit 142 and the state transition test condition decision unit 144 in the virtual register, and outputs the results as a report. Here, tens to hundreds of parameters for determining whether the test program passes or fails are used in the test program. Accordingly, the decision result output unit 146 outputs a pass/fail report for the test program for each parameter and the percentage of failed test programs in the entire test program. As a result, the ratio of the errors included in the test program to be emulated, namely, the errors not detected by the debugging process, are conveniently checked.

In some embodiments of the present invention, if the test program emulator 100 (refer to FIG. 3) is written in C-language, the source program is about 8000 lines long. When the errors for the AC timing condition and the state transition condition in a test program for testing DRAM devices, which is used in an actual test, are checked, the ratio of the errors for all of the parameters is about 0.9 to 5.2%.

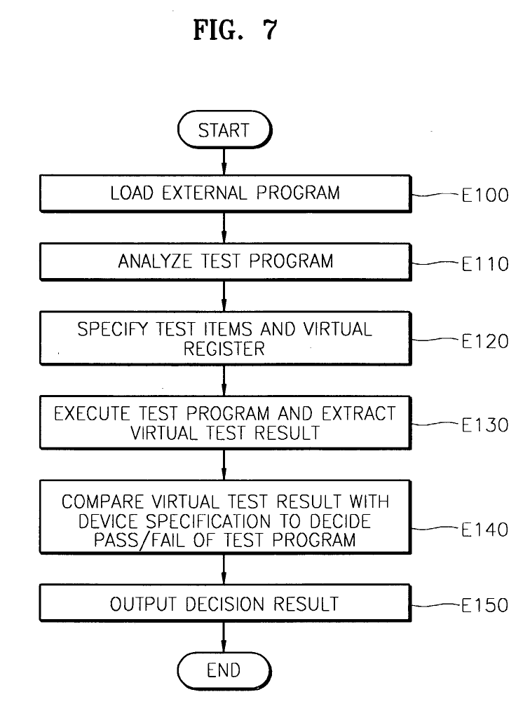

FIG. 7 is a flowchart that illustrates a test order in operating an emulator program in accordance with some embodiments of the present invention. Referring now to FIG. 7, at block E100, a test program emulator, which is run in a PC or a workstation, loads an external program. The external program may be a test program to be emulated, a device specification in the form of a computer file, and/or a waveform generator program.

After analyzing the test program, at block E110, test items to be emulated are specified from the test program based on the analysis result, and at block E120, the test items are stored in a virtual register of a computer. Thereafter, at block El 30, the test program is virtually operated to extract virtual test results from each command line of the test program. At block E140, the device specification in the form of a computer file is input to the test program emulator and compared with the virtual test results to determine whether the test program passes or fails. In comparing the device specification with the virtual test results, the waveform generator program is called as a subroutine to conveniently perform the comparison.

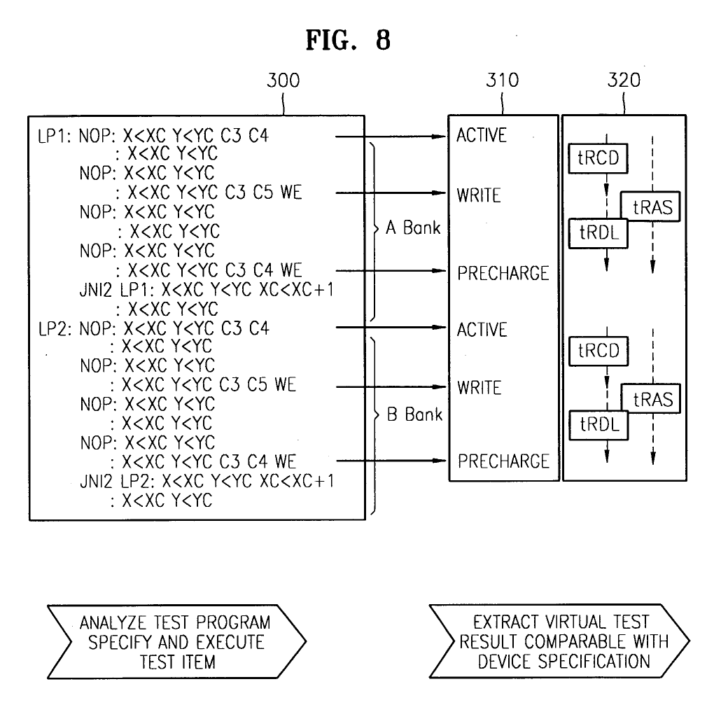

FIG. 8 is a block diagram that illustrates emulation operations of an emulator program using a test program in accordance with some embodiments of the present invention. Referring now to FIG. 8, a test program 300 in the form of lines is analyzed and test items are specified and executed to extract virtual test results, for example, a state transition condition 310 and an AC timing condition 320.

The state transition condition 310 specifies a memory bank of a DRAM and repeats “active,” “write,” and “precharge,” so as to test AC timing parameters, i.e., t_{RCD}, t_{RDL}, and t_{RAS}. The procedure is compared with a device specification in the form of a computer file in which the pass or fail of the procedure has been defined. In addition, the AC timing condition 320 analyzes and executes a test program to extract a range for establishing the AC timing condition 320. The range of the AC timing condition 320 is compared with the device specification in the form of a computer file.

In FIG. 8, the test program is described based on a program used in a tester marketed by Advantest Corporation while the state transition condition and the AC timing parameter are established for a DRAM. In addition, t_{RCI}) is a delay time from the RAS signal to the CAS signal, t_{RDL} is the minimum number of clock cycles from a “write” state to a “precharge” state, and t_{RAS} is the pulse width of the RAS signal.

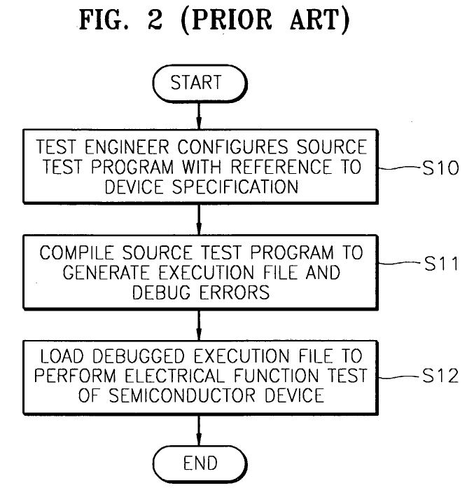

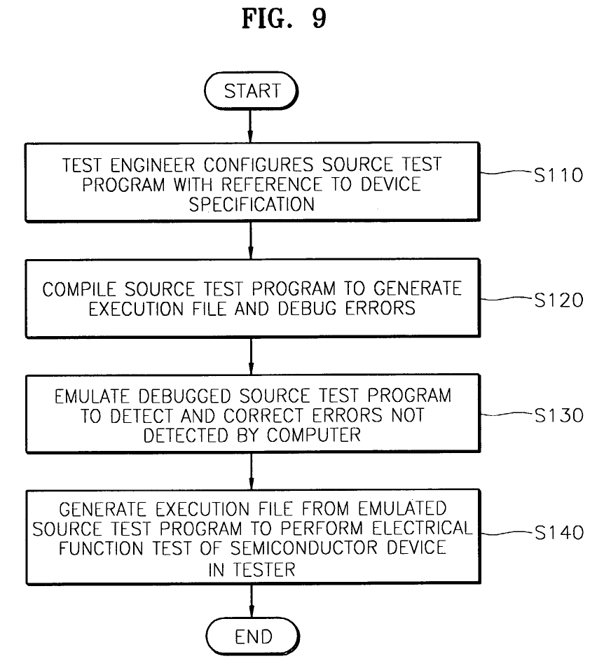

FIG. 9 is a flowchart that illustrates methods of operating a test program for testing an integrated circuit semiconductor device according to some embodiments of the present invention. Referring now to FIG. 9, in contrast to FIG. 2, errors that satisfy the criteria for using commands are not detected in the prior art because an emulation process is not performed after compiling and debugging a source test program in the prior art. A method for running a test program of an integrated circuit semiconductor device according to some embodiments of the present invention involves configuring a source test program at block S110 to compile the source test program, thereby generating an execution file, and performing a debugging process at block S120. The source test program, which has completed the debugging process, is emulated to detect and correct errors not detected by the debugging process at block S130. After the emulation process, the emulated source test program is compiled to generate an execution file, thereby performing an electrical function test of the semiconductor device in a tester.

Advantageously, according to embodiments of the present invention, a programmer is not required to manually check line-by-line whether a test program passes or fails. Instead, a test program emulator automatically corrects errors in a relatively short time. In addition, errors included in a test program are removed at an early stage to improve reliability of the test program so that defective integrated circuit semiconductor devices are screened in an electrical function test. Moreover, normal functioning integrated circuit semiconductor devices may not be wasted by mistakes caused by errors in a test program. Finally, using a test program emulator, in accordance with some embodiments of the present invention, may reduce the time taken to develop a new test program.

The flowcharts herein illustrate the architecture, functionality, and operations of embodiments of test program emulator software. In this regard, each block represents a module, segment, or portion of code, which comprises one or more executable instructions for implementing the specified logical function(s). It should also be noted that in other implementations, the function(s) noted in the blocks may occur out of the order noted in the flowcharts. For example, two blocks shown in succession may, in fact, be executed substantially concurrently or the blocks may sometimes be executed in the reverse order, depending on the functionality involved.

In concluding the detailed description, it should be noted that many variations and modifications can be made to the preferred embodiments without substantially departing from the principles of the present invention. All such variations and modifications are intended to be included herein within the scope of the present invention, as set forth in the following claims.

That which is claimed:

1. A test program emulator for an integrated circuit semiconductor device comprising:
an emulator control program that is configured to accept a device specification in the form of a computer file and a test program as inputs, to analyze the text of the test program to obtain test items, and to store the test items in a virtual register;
an emulator execution program that is configured to virtually execute the test program and to extract virtual test results of commands that are compatible with the device specification; and
an emulator decision program that is configured to compare the virtual test results with the device specification, to decide whether the test program passes or fails, and to output the decision result.

2. The test program emulator of claim 1, wherein the device specification and the test program are prepared for the same device.

3. The test program emulator of claim 1, wherein the device specification is written in a text type.

4. The test program emulator of claim 1, wherein the test program is a source code program.

5. The test program emulator of claim 1, wherein the test items comprise an alternating current (AC) timing specification and a state transition -specification of a semiconductor device.

6. The test program emulator of claim 1, wherein the virtual register of the emulator control program is a register of a computer in which the test program emulator is executed.

7. The test program emulator of claim 1, wherein the test program emulator further comprises a waveform generator that is configured to convert the device specification and the virtual test results into graphic format.

8. The test program emulator of claim 7, wherein the waveform generator is generated by a graphical user interface (GUI).

9. The test program emulator of claim 1, wherein the test items comprise an item for deciding whether the test program passes or fails.

10. The test program emulator of claim 1, wherein the test program emulator executes in a personal computer (PC) or a workstation.

11. A method of emulating a test program for testing an integrated circuit semiconductor device, comprising:
inputting an electrical test program for testing a semiconductor device into a computer;
analyzing the test program to establish test items;
executing the test program and extracting commands corresponding to the test items to obtain virtual test results;
comparing the virtual test results with a device specification to decide whether the test program passes or fails; and
outputting the decision result.

12. The emulation method of claim 11, wherein inputting the electrical test program comprises:
inputting the device specification into the computer.

13. The emulation method of claim 11, wherein the computer is a PC or a workstation.

14. The emulation method of claim 11, wherein analyzing the test program to establish test items comprises: establishing an AC timing specification and a state transition specification of the test program.

15. The emulation method of claim 11, wherein analyzing the test program to establish test items comprises:
specifying a virtual register in which-the virtual test results are stored.

16. The emulation method of claim 11, wherein executing the test program and extracting commands corresponding to the test items to obtain virtual test results comprises:
analyzing and executing the test program to specify a memory bank of a semiconductor device;
analyzing and executing the test program to extract a state transition condition of the semiconductor device; and
analyzing and executing the test program to extract an AC timing condition of the semiconductor device.

17. The emulation method of claim 11, wherein comparing the virtual test results with the device specification to decide whether the test program passes or fails comprises:
using a waveform generator that converts the text type virtual test results and the device specification into graphic format.

18. The emulation method of claim 11, wherein comparing the virtual test results with the device specification to decide whether the test program passes or fails comprises:
comparing a state transition condition of the semiconductor device and an AC timing condition extracted from the virtual test results with acceptable results contained in the device specification.

19. The emulation method of claim 11, wherein outputting the decision result comprises:
outputting pass or fail results of the test items and data indicating a percentage of the test items that passed or failed.

20. A method of operating a test program of an integrated circuit semiconductor device, comprising:
providing a source test program for a semiconductor device;
compiling and debugging the source test program to obtain an execution file and a debugged source test program;
emulating the debugged source test program to correct errors not detected during debugging; and
using the emulated source test program for an electrical test of the semiconductor device.

21. The method of claim 20, wherein emulating the debugged source test program comprises:
providing an emulator program for analyzing the test program;
comparing virtual test results extracted by the emulator program with a device specification; and
outputting the comparison result.

22. The method of claim 20, wherein the virtual test results include an AC timing test result and a state transition result.

23. A computer program product for emulating a test program for testing an integrated circuit semiconductor device, comprising:
a computer readable storage medium having computer readable program code embodied therein, the computer readable program code comprising:
computer readable program code configured to input an electrical test program for testing a semiconductor device into a computer;
computer readable program code configured to analyze the test program to establish test items;
computer readable program code configured to execute the test program and extract commands corresponding to the test items to obtain virtual test results;
computer readable program code configured to compare the virtual test results with a device specification to decide whether the test program passes or fails; and
computer readable program code configured to output the decision result.

24. The computer program product of claim 23, wherein the computer readable program code configured to input the electrical test program comprises:
computer readable program code configured to input the device specification into the computer.

25. The computer program product of claim 23, wherein the computer is a PC or a workstation.

26. The computer program product of claim 23, wherein the computer readable program code configured to analyze the test program to establish test items comprises:
computer readable program code configured to establish an AC timing specification and a state transition specification of the test program.

27. The computer program product of claim 23, wherein the computer readable program code configured to analyze the test program to establish test items comprises:
computer readable program code configured to specify a virtual register in which the virtual test results are stored.

28. The computer program product of claim 23, wherein the computer readable program code configured to execute the test program and extract commands corresponding to the test items to obtain virtual test results comprises:
computer readable program code configured to analyze and execute the test program to specify a memory bank of a semiconductor device;
computer readable program code configured to analyze and execute the test program to extract a state transition condition of the semiconductor device; and
computer readable program code configured to analyze and execute the test program to extract an AC timing condition of the semiconductor device.

29. The computer program product of claim 23, wherein the computer readable program code configured to compare the virtual test results with the device specification to decide whether the test program passes or fails comprises:
computer readable program code configured to use waveform generator that converts the text type virtual test results and the device specification into graphic format.

30. The computer program product of claim 23, wherein the computer readable program code configured to compare the virtual test results with the device specification to decide whether the test program passes or fails comprises:
computer readable program code configured to compare a state transition condition of the semiconductor device and an AC timing condition extracted from the virtual test results with acceptable results contained in the device specification.

31. The computer program product of claim 23, wherein the computer readable program code configured to output the decision result comprises:
computer readable program code configured to output pass or fail results of the test items and data indicating a percentage of the test items that passed or failed.

32. A computer program product for operating a test program of an integrated circuit semiconductor device, comprising:
a computer readable storage medium having computer readable program code embodied therein, the computer readable program code comprising:
computer readable program code configured to provide a source test program for a semiconductor device;
computer readable program code configured to compile and debug the source test program to obtain an execution file and a debugged source test program;
computer readable program code configured to emulate the debugged source test program to correct errors not detected during debugging; and
computer readable program code configured to use the emulated source test program for an electrical test of the semiconductor device.

33. The computer program product of claim 32, wherein the computer readable program code configured to emulate the debugged source test program comprises:
computer readable program code configured to provide an emulator program for analyzing the test program;
computer readable program code configured to compare virtual test results extracted by the emulator program with a device specification; and
computer readable program code configured to output the comparison result.

34. The computer program product of claim 32, wherein the virtual test results include an AC timing test result and a state transition result.
